(19) United States
(12) Patent Application Publication
(10) Pub. No.: US 2010/0085359 A1
(43) Pub. Date: Apr. 8, 2010

(54) SURFACE NORMAL RECONSTRUCTION FROM A SINGLE IMAGE

(75) Inventors: Tai-Pang Wu, Hong Kong (CN); Jian Sun, Beijing (CN); Heung-Yeung Shum, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,185

(22) Filed: Oct. 3, 2008

(51) Int. Cl. G06T 15/60

(52) U.S. Cl. 345/426

(57) ABSTRACT

The construction of a surface normal map from a single image is disclosed herein. One disclosed embodiment comprises determining an initial surface map comprising initial surface normals, and then receiving an input requesting manual modification of a set of normals in the initial surface map. Lastly, the set of surface normals is modified as requested by the input, to form the surface normal map.

### BACKGROUND

Shape recovery of a single two-dimensional (2D) image is designed to derive a three-dimensional (3D) description of the image, wherein the recovered shape may be expressed in one of several ways, such as depth, surface normal, surface gradient, or surface slant and tilt. Shape recovery by surface normal reconstruction allows the normals of a 2D image to be constructed, for use in graphics applications such as re-lighting, texture-mapping, material editing and surface decoration. Here, each normal may be defined as a vector perpendicular to the tangent plane on the object surface, wherein the object surface is represented by the 2D image.

One approach to surface normal reconstruction is known as Shape-from-Shading (SfS), and involves computing surface normals from shading information in a single image. In one approach, SfS may be carried out by an automatic SfS algorithm applied to a single image. However, a disadvantage of Sfs is that SfS calculations may be error-prone due to the ill-posedness of the Sfs problem, in that restrictions and assumptions used in SfS algorithms may make them insufficient in producing high-quality surface normals.

Another approach to surface normal reconstruction is an interactive approach, in which a user specifies surface positions or absolute surface normals as constraints. However, a disadvantage of such interactive methods is that for an image with complex geometry and/or much high frequency data, a large number of constraints may need to be specified by the user, thereby making the method difficult and cumbersome.

### SUMMARY

Various embodiments related to the construction of a surface normal map are disclosed herein. For example, one disclosed embodiment comprises a method of constructing a surface normal map from a single image in which an initial surface map comprising initial surface normals is first determined, and then an input requesting manual modification of a set of normals in the initial surface map is received. Lastly, the set of surface normals is modified as requested by the input, to form the surface normal map.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a process flow depicting an embodiment of a method of constructing a surface normal map from a single image.

FIG. 2 shows a process flow depicting another embodiment of a method of constructing a surface normal map from a single image.

FIG. 3 shows a graphical depiction of a construction of a relative height between two neighboring pixels according to an embodiment of the present disclosure.

FIG. 4 shows an embodiment of an image capture and processing system.

FIG. 5 shows an embodiment of a graphical user interface control in the form of a projection of a sphere manipulable to manually adjust an initial surface normal.

FIG. 6 shows a graphical depiction of a rotation effect applied to an initial surface normal in response to an input received from the control embodiment of a FIG. 5.

### DETAILED DESCRIPTION

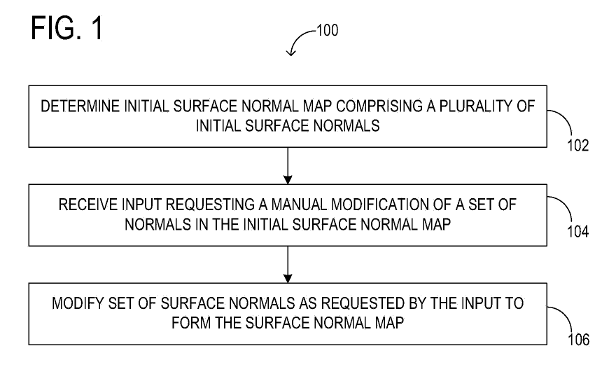

FIG. 1 illustrates a process flow depicting an embodiment of a method 100 for constructing a surface normal map from a single image. Method 100 first comprises, at 102, determining an initial surface normal map comprising a plurality of initial surface normals. This may be done by any suitable method. One such method employs an automatic computation using a SfS algorithm, or by any other automated mathematical approach that does not utilize user input of normals.

Next, at 104, method 100 comprises receiving an input requesting a manual modification of a set of normals in the initial surface normal map. Such a manual modification may be used to adjust or correct apparent errors present in the initial surface normal map resulting from the automatic computation. Method 100 then comprises, at 106, modifying the set of surface normals as requested by the input to form the surface normal map. In some embodiments, processes 104 and 106 may be accomplished via a user input received from a graphic user interface.

Method 100 provides for the convenience and automation of computational surface normal constructions, such as SfS processes, while allowing user control to adjust apparent errors in the normals, as allowed by user-defined surface normal reconstructions. As described below, errors from the SfS process may be more apparent in low frequency regions of the image than in high frequency regions. As such, the calculation of the initial surface normal map may provide satisfactory results in high frequency regions of an image. Therefore, the manual adjustment of the initial surface normal map to form the surface normal map may be limited to lower frequency regions of the image, which may allow the adjustments to be made in a relatively simple manner compared to methods in which all normals are manually defined.

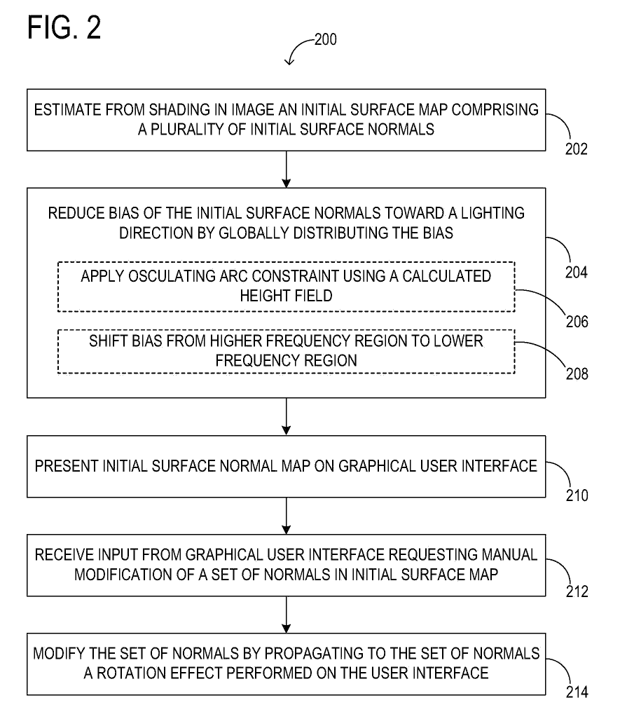

Method 100 may be implemented in any suitable manner. One example of a suitable implementation of method 100 is shown in FIG. 2 as method 200. Method 200 first comprises, at 202, estimating from shading in an image an initial surface map comprising a plurality of initial surface normals. Such a shading approach to surface normal estimation may comprise using an SfS algorithm based on the premise that when a lighting direction and surface albedos (i.e. diffuse reflectivity) for an image are unknown, the same image may be obtained by a family of surfaces.

In one embodiment of a SfS algorithm, the initial normal estimation follows the Lambertian assumption. In such an approach, the input image I may be defined by the following imaging model,

I=ρN^{T}L,

where ρ is the surface albedo, N=(nₓ, n_{y}, n_{z})^{T} is a unit vector representing the surface normal, and L=(lₓ, l_{y}, l_{z})^{T} is a unit vector representing the direction of a distant light source. All the quantities on the right hand side of the above equation may be unknown. To obtain the lighting direction L, the approach involves a user assigning normals to a few pixels and minimizing the following energy:

$${E}_{1} = {\sum }_{i ∈ ℒ}^{ } {‖ {I}_{i} - {N}_{i}^{T} {L}^{′} ‖}^{2}$$

where L is a set of user selected pixels and L′=ρL. In some embodiments, the user assigning normals to a few pixels comprises assigning normals to three or more pixels.

Continuing with the above imaging model, the unit lighting direction may be obtained by

$$L = \frac{{L}^{′}}{‖ {L}^{′} ‖} .$$

Such an estimation may be performed a single iteration in some embodiments. Using the estimated L, the normals N and albedo ρ may be computed by minimizing the following energy:

$${E}_{2} = {\sum }_{i ∈ 𝒫}^{ } {‖ {ρ}^{′} {I}_{i} - {N}_{i}^{T} L ‖}^{2} + λ {\sum }_{\{ i , j \}}^{ } {‖ {N}_{i} - {N}_{j} ‖}^{2}$$

where P is the user selected region to be processed, {i, j} is a first-order neighbor pair, λ is a regularization factor, and ρ′=ρ⁻¹. The first term in the above energy function measures the fitness of the imaging model, and the second term enforces a smoothness constraint on the normals.

Since the above energy function may be a quadratic function, a Gauss-Seidel method may be used to minimize the energy with successive over-relaxation. In each iteration, the unit-length constraint of Nᵢ may be enforced by re-projecting the updated Nᵢ onto a unit sphere and ρ′ may be restricted in the range ρ′≧1 since 0≦ρ≦1.

The normal map generated by the minimization of energy E₂ may have a bias toward the input lighting direction. The bias may be eased by evenly distributing the error. Method 200, at 204, therefore comprises reducing a bias of the initial surface normals toward a lighting direction by globally distributing the bias. Any suitable method may be used to reduce the bias. One such approach is a surface reconstruction method comprising applying an osculating arc constraint using a calculated height field, as shown in method 200 at 206.

To evenly distribute the error, such a height field may be constructed by minimizing the following energy, in which the lighting direction may be absent:

$${E}_{3} = {\sum }_{\{ i , j \}}^{ } {( ( {h}_{i} - {h}_{j} ) - {q}_{ij} )}^{2} ,$$

where hᵢ and hⱼ are the heights at i and j, and qᵢⱼ is the relative height between i and j on the surface. The height field, H is then a set of heights such that H={hᵢ}. In other methods, qᵢⱼ may be calculated from the surface gradient

$$( \frac{\partial f}{\partial x} = \frac{{n}_{x}}{{n}_{z}} , \frac{\partial f}{\partial y} = \frac{{n}_{y}}{{n}_{z}} ) .$$

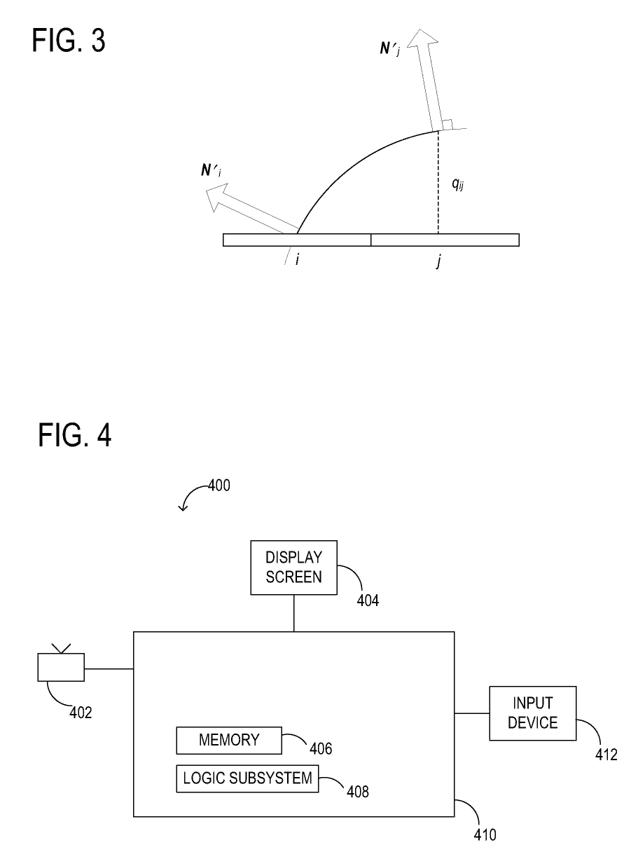

However, the gradient may be infinite when the normal is perpendicular to the viewing detection, such as when an occlusion boundary is manifested as the object's silhouette in 2D images. To avoid such gradients from approaching infinity, the relative height qᵢⱼ may be calculated directly from normals by using a smooth connection which is shown in FIG. 3 and described as follows.

FIG. 3 shows a graphical depiction of a construction of a relative height between two neighboring pixels according to an embodiment of the present disclosure. Such a graphical depiction shows the calculation of a relative height qᵢⱼ between two neighboring pixels i=(x, y) and j=(x+1, y) along the x-direction in the image. Normals Nᵢ and Nⱼ may be projected onto a vertical plane, which may be parallel to the x-direction, to obtain two vectors N′₁ and N′ⱼ. An osculating arc may be fit between the two projected normals. Such an arc may be uniquely defined by N′₁ and N′ⱼ where their tangents touch the arc, resulting in a minimal curvature connection between i and j. Such a use of geometric smoothness as described above may avoid numerical instabilities due to ill-defined surface gradients

$$\frac{\partial f}{\partial x} or \frac{\partial f}{\partial y}$$

which may be typical of a complex surface containing orientation discontinuities. After surface reconstruction, the normal is recomputed directly from the height field.

Returning to FIG. 2, the result of reducing the bias toward the lighting direction is to shift some bias from a higher frequency region in the image to a lower frequency region, as indicated at 208. Thus, errors resulting from the surface reconstruction step may occur in the lower frequency region, and therefore may be easier for a user to edit using interactive manipulation than errors occurring in higher frequency regions.

Method 200 next comprises, at 210, presenting the initial surface normal map on a graphical user interface configured to allow a user to modify the initial normal surface map. Such a manual editing process may allow the user to correct errors in the lower frequency regions, and additionally to further enhance higher frequency surface details if desired. Accordingly, method 200, at 212, comprises receiving input from the graphical user interface requesting manual modification of a set of normals in the initial surface map.

Lastly, method 200 at 214 comprises modifying the set of normals by propagating to the set of normals a rotation effect performed on the user interface. Since most noticeable errors in the initial normal map may lie in the lower frequency regions, normals may be manipulated by specifying a relative normal ΔN, ideally equal to N′-N, rather than working with absolute normals. Working with absolute normals may require the user to specify many constraints; therefore it may be easier for a user to specify constraints in a smooth, lower frequency, relative normal map. Such a specification may be performed by propagating a small number of user manipulations to the normal map.

Any suitable method may be used to construct the relative normals. In one such method, the user manipulates the normal N by a rotational transformation to produce the rotated normal N′=R(N; s, t), where s and t are the slant and tilt for the rotation. Such an approach may allow for easy user interaction on a 2D graphical user interface, as the user may simply draw points or strokes on a circle to provide a sample (s, t).

Formally, N is rotated by a rotation matrix R={r₁, r₂, v} where

$${r}_{1} = - \frac{v \times {r}_{2}}{‖ v \times {r}_{2} ‖} , {r}_{2} = \frac{v \times a}{‖ v \times a ‖} ,$$

a=(0, 0, 1) and v=(cos t sin s, sin t sin s, cos s)^{T}, where (s, t) are specified by the user via a graphical user interface, as described at 212 in method 200. Furthermore, the user may only need to specify a sparse set of rotational transformations in terms of (s, t).

Such a rotation approach comprises an optimization method to propagate the user inputs. Any suitable optimization method may be used. One such approach comprises an optimization method to propagate the user inputs by minimizing the following energy function with respect to vᵢ:

$${E}_{4} = {\sum }_{i ∈ 𝒰 •}^{ } {‖ {v}_{i} - {v}_{i}^{′} ‖}^{2} + β {\sum }_{\{ i , j \}}^{ } {‖ {v}_{i} - {v}_{j} ‖}^{2} ,$$

where v′ᵢ is the user selected rotation vector on a graphical user interface comprising a sphere image, μ is the set of user-specified pixels and β is a regularization factor which may be set to a fixed value of 0.005 in one embodiment. In other embodiments, the regularization factor may have a value in a range of 0.001 to 0.01.

Such a rotation approach may provide two types of user interaction for editing the initial normal map from a sphere palette interface, namely surface control and user embedding. Surface control comprises a user picking a point or drawing a stroke to specify the desired rotations from a sphere. The rotation effect may then be propagated by the above equation for E₄. Detail embedding comprises the user enhancing surface details by selecting a region of interest from the input image. Image gradients inside this region may then be converted into a set of vectors,

$$v = \frac{1}{\sqrt{1 + \frac{δ {I}^{2}}{δ x} + \frac{δ {I}^{2}}{δ y}}} {( \frac{δ I}{δ x} , \frac{δ I}{δ y} , 1 )}^{T} ,$$

where the corresponding normals are rotated by this set of vectors v. The normals may be updated by Ñ=(1−α)N+αN′ where N′ is the rotated N and α controls the contribution of the new normal. In some embodiments, α may be set to a fixed value of 0.2, while in other embodiments this term my have a value in a range of 0.1 to 0.5. Detail embedding may also be used to synthesize surface details when unwanted structures are removed.

Methods 100 and 200 may be implemented in any suitable use environment. FIG. 4 shows one embodiment of a suitable use environment in the form of an image capture and processing system 400. Image capture and processing system 400 comprises image capture device 402 from which an image is received for processing. In some embodiments image capture device 402 may be a digital camera, a scanner or a storage device storing a digital image.

Image capture and processing system 400 further comprises computing device 410, which comprises memory 406 and logic subsystem 408. In some embodiments, computing device 410 may be a computer, such as a desktop computer, laptop computer, notebook computer, etc. In other embodiments, computing device 410 may be an on-board microprocessor on a digital camera, video camera, or other portable image capture device. Memory 406 may comprise instructions stored thereon that are executable to perform one or more of the methods disclosed herein.

Image capture and processing system 400 further comprises a display screen 404 for viewing images and for displaying a graphical user interface for manipulating an initial surface normal map. In some embodiments, display screen 404 may be a computer monitor or a projection screen. In other embodiments, display screen may be a monitor or viewing screen integrated with a camera, video camera or other portable image capture device.

Image capture and processing system 400 further comprises input device 412 for receiving input from the user. In some embodiments, input device 412 may be a mouse or touch-pad configured to allow a user to interact with a graphical user interface for modifying an initial surface normal map. In other embodiments, input device may be any other suitable input device, such as a touch screen input, etc.

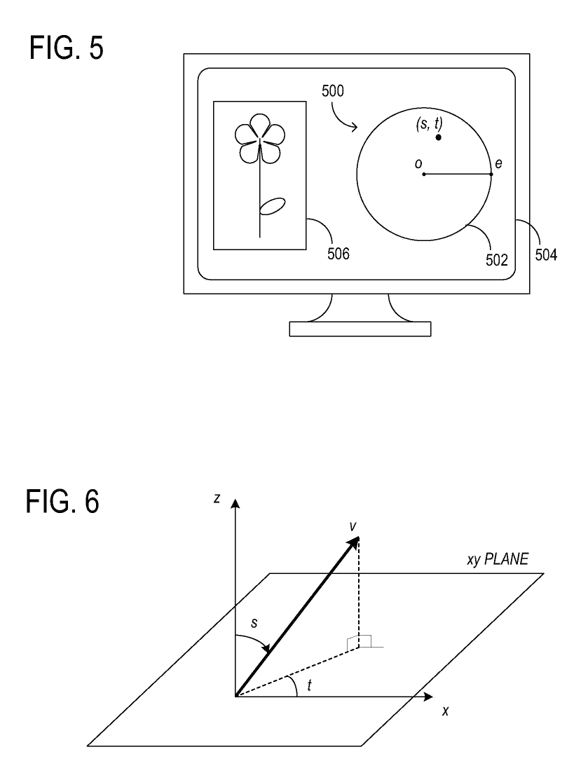

Any suitable user interface may be used to allow a user to manipulate the initial surface normal map. FIG. 5 shows an embodiment of a suitable graphical user interface 500 in the form of an orthographic projection (i.e. a 2D view) of a sphere 502 manipulable to manually adjust an initial surface normal. The graphical user interface 500 is displayed on a computer monitor screen 504.

A user may manipulate initial surface normals on a surface normal map 506 by picking a point or drawing a stroke on the 2D view of a sphere 502. The initial surface normals are manipulated via a rotation specified by a rotational transformation calculated from the user input (s, t) on the 2D view of a sphere 502, as described above in method 200 at 214.

An example of how manipulations specified by the user on the 2D view of a sphere 502 are applied to the surface normal map 506 is as follows. From the definition of R as described above in method 200 at 214, the user selecting a vector at o on the 2D view of a sphere 502 produces zero rotation and likewise no manipulation of the initial surface normals in the surface normal map 506. However, the user moving along the line from o to e on the 2D view of a sphere 502, corresponds to moving along the pertinent arc of the sphere. Thus, as the length |oe| increases, the angle of rotation also increases while the axis of the rotation remains unchanged. Thus, the 2D view of a sphere 502 may provide a convenient means for the user to control the strength of the transformation, measured by |oe|, applied to the initial surface normals in the existing surface normal map 506.

FIG. 6 shows a graphical depiction of a rotation effect applied to an initial surface normal in response to an input received from the control embodiment of FIG. 5. Referring to point (s,t) in FIG. 5, the rotation effect described in method 200 at 214 is initiated by the input (s, t) received from the user on a graphical user interface, such as via the 2D view of a sphere 502 shown in FIG. 5. Interpreting the inputs slant s and tilt t in a Cartesian coordinate system allows for the construction of a vector v according to v=(cos t sin s, sin t sin s, cos s)^{T} as described in method 200 at 214. An embodiment of vector v is shown in FIG. 6.

After the user selects a set of inputs (s, t), each input resulting in a vector vᵢ, a rotation effect may then be obtained as described in method 200 and 214 by minimizing an energy function E₄ respect to vᵢ. The rotation effect may then be propagated to the image. In one embodiment, the rotation effect may be propagated to whole image, such that the set of initial surface normals that are modified comprises all initial surface normals. In another embodiment, the rotation effect may be propagated to a user specified region of the image, such that the set of initial surface normals that are modified comprises a subset of the entire set of initial surface normals.

It will be appreciated that the computing device described herein may be any suitable computing device configured to execute the programs described herein. For example, the computing device may be a mainframe computer, personal computer, laptop computer, portable data assistant (PDA), computer-enabled wireless telephone, other suitable computing device, and/or combinations thereof. Such are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It will be understood that the embodiments described herein are exemplary in nature, and that these specific embodiments or examples are not to be considered in a limiting sense, because numerous variations are contemplated. Accordingly, the present disclosure includes all novel and non-obvious combinations and sub-combinations of the various systems and methods disclosed herein, as well as any and all equivalents thereof.

1. In a computing device, a method of constructing a surface normal map from a single image, the method comprising:
determining an initial surface normal map comprising a plurality of initial surface normals;
receiving an input requesting a manual modification of a set of normals in the initial surface normal map; and
modifying the set of surface normals as requested by the input to form the surface normal map.

2. The method of claim 1, wherein determining the initial surface normal map comprises determining the initial surface normal map from shading in the single image.

3. The method of claim 1, further comprising presenting an image of the initial surface normal map on a graphical user interface, and wherein receiving the input comprises receiving the input from the graphical user interface.

4. The method of claim 3, wherein presenting the image of the initial surface normal map on the graphical user interface comprises displaying a two-dimensional input interface that comprises a control in a form of a projection of a sphere, and wherein receiving the input and modifying the initial set of surface normals comprises propagating to the set of surface normals a rotation effect applied to the control.

5. The method of claim 1, wherein determining the initial surface normal map comprises reducing a bias of the initial surface normals toward a lighting direction in the single image by globally distributing the bias across the initial surface normal map.

6. The method of claim 5, wherein globally distributing the bias comprises utilizing an osculating arc constraint comprising applying a calculated height field comprising a plurality of relative heights on the surface normal map, wherein each relative height is calculated from a pair of adjacent initial surface normals defining a corresponding osculating arc.

7. The method of claim 5, wherein globally distributing the bias comprises shifting bias from a higher frequency region of the image to a lower frequency region of the image.

8. The method of claim 7, wherein receiving an input requesting the manual modification of the set of normals comprises receiving an input requesting the manual modification of a set of normals in the lower frequency region of the image.

9. A computing device, comprising:
a logic subsystem; and
memory comprising instructions executable by the logic subsystem to perform a method of constructing a surface normal map from a single image, the method comprising:
determining an initial surface normal map comprising a plurality of initial surface normals from shading in the image;
receiving an input requesting a manual modification of a set of normals in the initial surface normal map; and
modifying the set of surface normals as requested by the input to form the surface normal map.

10. The computing device of claim 9, wherein the instructions are further executable to determine the initial surface normal map by reducing a bias of the initial surface normals toward a lighting direction in the single image by globally distributing the bias across the initial surface normal map.

11. The computing device of claim 10, wherein the instructions are executable to globally distribute the bias by utilizing an osculating arc constraint comprising applying a calculated height field comprising a plurality of relative heights on the surface normal map, wherein each relative height is calculated from a pair of adjacent initial surface normals defining a corresponding osculating arc.

12. The computing device of claim 9, wherein the instructions are further executable to present an image of the initial surface normal map on a graphical user interface, and wherein receiving the input comprises receiving the input from the graphical user interface.

13. The computing device of claim 12, wherein the instructions are executable to present the image of the initial surface normal map on a graphical user interface by displaying a two-dimensional input interface that comprises a control in a form of a projection of a sphere, and wherein receiving the input and modifying the initial set of surface normals comprises propagating to the set of surface normals a rotation effect applied to the control.

14. A computer-readable storage medium comprising instructions stored thereon that are executable by a computing device to perform a method of constructing a surface normal map from a single image, the method comprising:
estimating from shading in the image an initial surface normal map comprising a plurality of initial surface normals; reducing a bias of the initial surface normals toward a lighting direction in the single image by globally distributing the bias across the initial surface normal map;
receiving an input requesting manual modification of a set of normals in the initial surface normal map; and
modifying the set of normals in the initial surface normal map as requested by the input received to form the surface normal map.

15. The computer-readable storage medium of claim 14, wherein globally distributing the bias comprises utilizing an osculating arc constraint comprising applying a calculated height field comprising a plurality of relative heights on the surface normal map, wherein each relative height is calculated from a pair of adjacent initial surface normals defining a corresponding osculating arc.

16. The computer-readable storage medium of claim 15, wherein globally distributing the bias comprises shifting bias from a higher frequency region of the image to a lower frequency region of the image.

17. The computer-readable storage medium of claim 16, wherein receiving the input requesting manual modification of the set of normals comprises receiving an input requesting the manual modification of a set of normals in the lower frequency region of the image.

18. The computer-readable storage medium of claim 14, wherein receiving the input requesting manual modification of the set of normals in the initial surface normal map comprises presenting the initial surface normal map on a graphical user interface and receiving the input from the graphical user interface.

19. The computer-readable storage medium of claim 18, wherein the graphical user interface comprises a control in a form of a two-dimensional orthographic projection of a sphere, and wherein receiving the input comprises receiving a graphical manipulation of the control.

20. The computer-readable storage medium of claim 18, wherein modifying the set of normals in the initial surface map comprises propagating to the set of normals a rotation effect applied to the control.
